(19) United States
(12) Patent Application Publication
(10) Pub. No.: US 2005/0063798 A1
(43) Pub. Date: Mar. 24, 2005

(54) Interchangeable workpiece handling apparatus and associated tool for processing microfeature workpieces

(76) Inventors: Jeffry Alan Davis, Kalispell, MT (US); Randy A. Harris, Kalispell, MT (US)

Correspondence Address: PERKINS COIE LLP;PATENT-SEA, P.O. BOX 1247, SEATTLE, WA, 98111-1247, US

(21) Appl. No.: 10/860,592

(22) Filed: Jun. 3, 2004

Related U.S. Application Data
(60) Provisional application No. 60/476,786, filed on Jun. 6, 2003.
(60) Provisional application No. 60/476,776, filed on Jun. 6, 2003.
(60) Provisional application No. 60/476,333, filed on Jun. 6, 2003.
(60) Provisional application No. 60/476,881, filed on Jun. 6, 2003.
(60) Provisional application No. 60/501,566, filed on Sep. 9, 2003.

(51) Int. Cl. B65G 1/00

(52) U.S. Cl. 414/217

(57) ABSTRACT

Interchangeable workpiece handling apparatuses and associated tools for processing microfeature workpieces are disclosed. In one embodiment, an apparatus includes a device support having a first alignment surface at an alignment plane. A processing chamber is received in an aperture at the alignment plane. A workpiece handling device is positioned proximate to the processing chamber and includes a workpiece support, a drive unit operatively coupled to the workpiece support to move the workpiece support along a generally linear motion axis, and a mounting portion coupled to the workpiece support and having a second alignment surface removably mated with the first alignment surface. In a particular embodiment, the workpiece handling device is supported relative to the device support only at or above the alignment plane. Accordingly, the workpiece handling device can be easily removed from the device support and need not impede access to components beneath the alignment plane.

### CROSS-REFERENCE TO RELATED APPLICATIONS

The present application claims the benefit of U.S. Application No. 60/476,786 filed on Jun. 6, 2003 and No. 60/476,776 filed on Jun. 6, 2003, both of which are incorporated herein in their entirety, including appendices, by reference. Additionally, U.S. Application No. 60/476,333 filed on Jun. 6, 2003; No. 60/476,881 filed on Jun. 6, 2003; and No. 60/501,566 filed on Sep. 9, 2003, are also incorporated herein in their entirety, including appendices, by reference.

### TECHNICAL FIELD

The present invention is directed toward apparatuses and methods for processing microfeature workpieces having a plurality of microdevices integrated in and/or on the workpiece. The microdevices can include submicron features. Additional aspects of the present invention include a workpiece handling device that is precisely mounted to a tool and that can be removed and replaced without recalibration.

### BACKGROUND

Microdevices are manufactured by depositing and working several layers of materials on a single substrate to produce a large number of individual devices. For example, layers of photoresist, conductive materials, and dielectric materials are deposited, patterned, developed, etched, planarized, and so forth to form features in and/or on a substrate. The features are arranged to form integrated circuits, micro-fluidic systems, and other structures.

Wet chemical processes are commonly used to form features on microfeature workpieces. Wet chemical processes are generally performed in wet chemical processing tools that have a plurality of individual processing chambers for cleaning, etching, electrochemically depositing materials, or performing combinations of these processes. FIG. 1 schematically illustrates an integrated tool 10 that can perform one or more wet chemical processes. The tool 10 includes a housing or cabinet 11 that encloses a platform 50, a plurality of wet chemical processing stations 20, and a transport system 12. Each processing station 20 includes a vessel or chamber 40 and a lift-rotate unit 30 for transferring the workpieces W into and out of the chamber 40. The stations 20 can include rinse/dry chambers, cleaning capsules, etching capsules, electrochemical deposition chambers, or other types of wet chemical processing vessels. The transport system 12 includes a linear track 14 and a robot 13 that moves along the track 14 to transport individual workpieces W within the tool 10. The integrated tool 10 further includes a workpiece storage unit 15 having a plurality of containers 16 for holding workpieces W. In operation, the robot 13 transports workpieces to/from the containers 16 and the processing stations 20 according to a predetermined workflow schedule within the tool 10.

One concern associated with integrated wet chemical processing tools is that the chambers 40 and/or the lift/rotate units 30 must be maintained and/or repaired periodically. In electrochemical deposition chambers, for example, the electrodes degrade over time because the electrodes react with the electrolytic solution in a manner that consumes the electrodes. The shape of the electrodes accordingly changes, causing variations in the electrical field. The electrodes must be replaced periodically to maintain the desired deposition parameters across the workpiece. Electrochemical deposition chambers must also be maintained to clean or replace the electrical contacts that contact the workpiece W. During maintenance and/or repair, the electrochemical deposition chamber 40 is typically removed from the tool 10 and replaced with an extra chamber.

One problem with repairing or maintaining wet chemical processing chambers 40 is that it is time consuming to remove and replace the chamber 40 or other components of the processing station 20. For example, after a processing chamber 40 fails to meet performance specifications, it is shut down and removed from the platform 50. A pre-maintained processing chamber 40 is mounted to the platform 50 at the vacant position, and then the robot 13 and the lift-rotate unit 30 are recalibrated to operate with the new processing chamber 40. If the lift/rotate unit 30 fails to meet specifications, it must be removed and replaced, which also entails recalibrating the new lift/rotate unit 30 and the robot 13. Recalibrating the robot 13 and the lift-rotate unit 30 is a time-consuming process that increases the downtime for repairing or maintaining the processing station 20. As a result, when only one processing station 20 of the tool 10 does not meet specifications, it is often more efficient to continue operating the tool 10 without stopping to repair the one processing station 20 until more processing stations 20 do not meet the performance specifications. The loss of throughput of a single processing station 20, therefore, is not as severe as the loss of throughput caused by taking the tool 10 offline to repair or maintain a single one of the processing stations 20.

The practice of operating the tool 10 until at least two processing stations 20 do not meet specifications severely impacts the throughput of the tool 10. Clearly, if the tool 10 is not repaired or maintained until at least two or three processing stations 20 are out of specification, then the tool 10 operates at only a fraction of its full capacity for a period of time before it is taken offline for maintenance. This increases the operating costs of the tool 10 because the throughput not only suffers while the tool 10 is offline during component replacement and recalibration, but also while the tool 10 is online and operating at only a fraction of its full capacity. Moreover, as the workpiece feature sizes decrease, the processing stations 20 must consistently meet much higher performance specifications. This causes the processing stations 20 to fall out of specification sooner, which results in shutting down the tool 10 more frequently. Therefore, the downtime associated with repairing and/or maintaining components of processing stations, including lift/rotate units, electrochemical deposition chambers and other types of wet chemical processing chambers is significantly increasing the cost of operating wet chemical processing tools.

### SUMMARY

The present invention is directed toward interchangeable workpiece handling devices and associated tools for processing microfeature workpieces. The workpiece handling device can support a workpiece such as a wafer at a processing station to undergo a process such as electrochemical deposition. By making the workpiece handling devices interchangeable, they can be easily and quickly replaced and can therefore reduce the time during which the processing tool is down for maintenance. Furthermore, in some embodiments, the workpiece handling devices need not be calibrated after they are installed and prior to use. For example, in one embodiment, an apparatus for handling microfeature workpieces includes a device support having a first alignment surface at an alignment plane, a chamber aperture, processing chamber received in the chamber aperture, and a workpiece handling device. The workpiece handling device includes a workpiece support positioned to carry the workpiece at a processing position of the chamber, a drive unit operatively coupled to the workpiece support to translate the workpiece along a generally linear motion axis, and a mounting portion coupled to the workpiece support and having a second alignment surface removably mated with the first alignment surface. The workpiece handling device is supported relative to the device support only at or above the alignment plane. As a result, the workpiece handling device can be easily removed and replaced, and need not interfere with access to components of the apparatus located beneath the alignment plane.

In other embodiments, the drive unit is coupled to the microfeature workpiece support at an interface with a driven portion of the support, and moves the interface from a first end position to a second end position. A mounting surface of the handling device can be positioned in an alignment plane that does not intersect the translation axis between the first and second end positions.

Methods in accordance with other embodiments of the invention can reduce the time required to replace the workpiece handling devices. For example, in one embodiment, a first workpiece handling device having a first workpiece support and a first drive unit to translate the support along a first translation axis is removed from a workpiece processing tool and replaced with a second workpiece handling device. The second workpiece handling device includes a second workpiece support and a second drive unit. The method further includes moving microfeature workpieces to and from the second workpiece handling device after replacing the first workpiece handling device and without calibrating the second workpiece handling device after replacing the first workpiece handling device.

A method in accordance with another embodiment of the invention includes disconnecting both electrical and fluid communication to a first workpiece handling device by moving at least one of a first connector assembly coupled to the tool and a second connector assembly coupled to the first workpiece handling device relative to the other along a single axis in a first direction. The method further includes connecting both electrical and fluid communication to a second workpiece handling device by moving at least one of the first connector assembly and a third connector assembly coupled to the second workpiece handling device relative to the other along the single axis in a second direction opposite the first direction. Accordingly, the electrical and fluid communication links between the tool and the workpiece handling device are easily disconnected and reconnected when replacing one handling device with another.

### BRIEF DESCRIPTION OF THE DRAWINGS

FIG. 1 is a schematic top plan view of a wet chemical processing tool configured in accordance with the prior art.

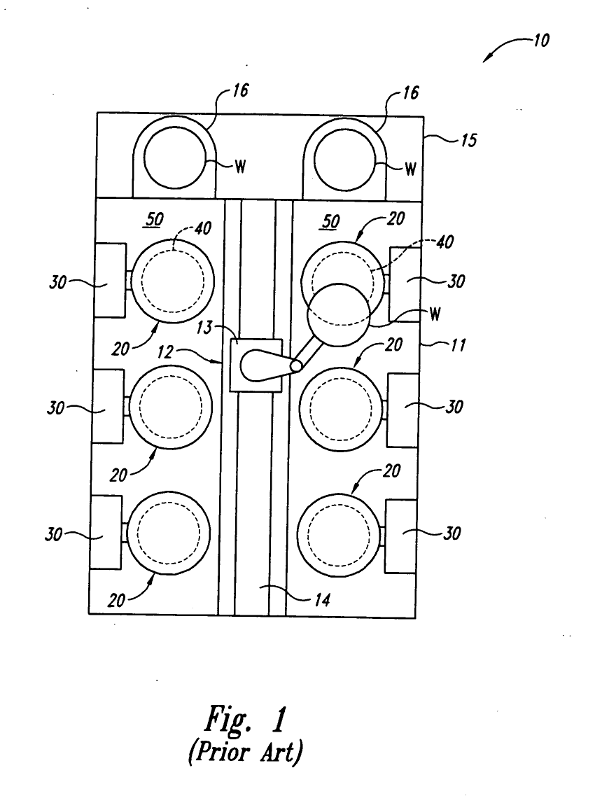

FIG. 2A is an isometric view of a wet chemical processing tool configured in accordance with an embodiment of the invention.

FIG. 2B is a top plan view of a wet chemical processing tool configured in accordance with an embodiment of the invention.

FIG. 3 is an isometric view of a mounting module for use in a wet chemical processing tool in accordance with an embodiment of the invention.

FIG. 4 is a partially schematic, isometric view of a workpiece handling apparatus configured in accordance with an embodiment of the invention.

FIG. 5 is a partially schematic, isometric illustration of the workpiece handling apparatus shown in FIG. 4, highlighting internal features.

FIG. 6 is a partially schematic, endview of an arrangement for supporting fluid and electrical communication lines in accordance with an embodiment of the invention.

FIG. 7 is a partially schematic, exploded view of a workpiece support head configured in accordance with an embodiment of the invention.

FIG. 8 is a partially schematic, isometric illustration of a workpiece handling apparatus configured to lift a workpiece in accordance with an embodiment of the invention.

FIG. 9 is an illustration of internal features of an embodiment of the workpiece handling apparatus shown in FIG. 8.

### DETAILED DESCRIPTION

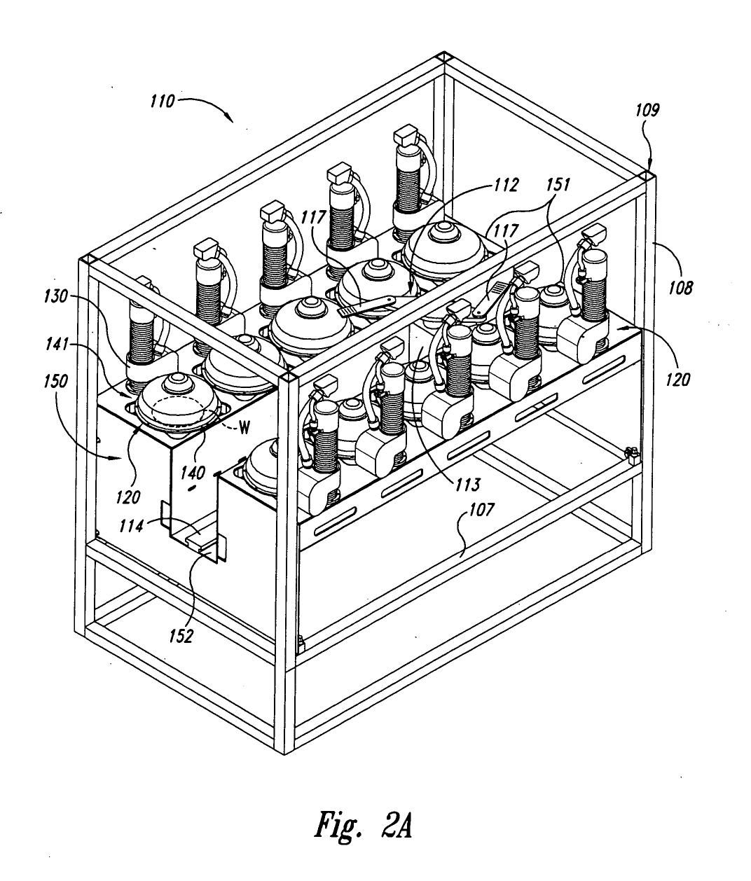

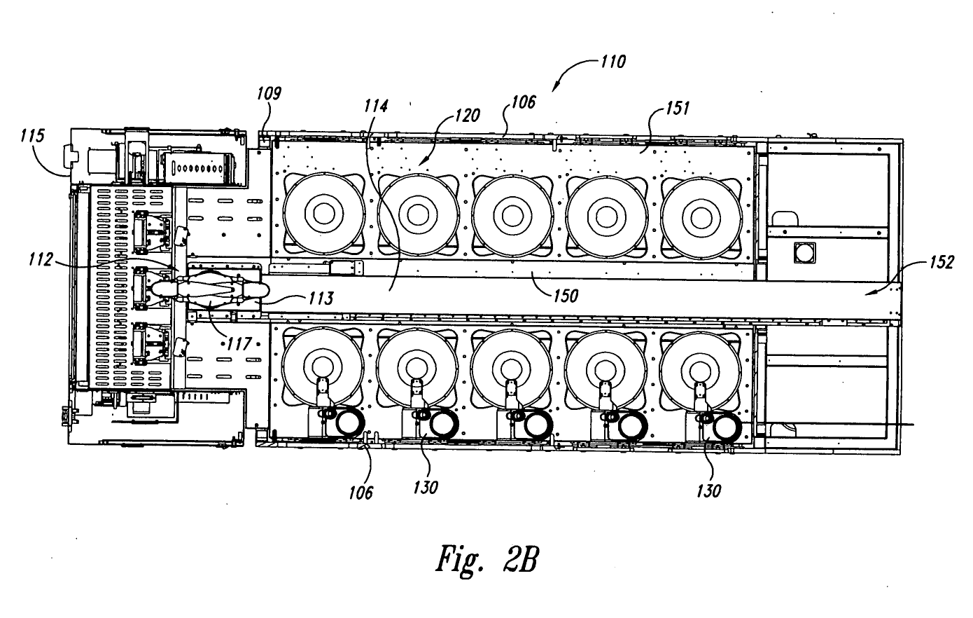

The description is divided into the following sections, which together refer to FIGS. 2A-9: (A) Introduction; (B) Embodiments of Integrated Tools With Mounting Modules; (C) Embodiments of Dimensionally Stable Mounting Modules for Use in integrated Tools; and (D) Workpiece Handling Units for Use With Processing Vessels. A person skilled in the art will understand, however, that the invention may have additional embodiments, or that the invention may be practiced without several of the details of the embodiments shown in FIGS. 2A-9.

A. Introduction

As used herein, the terms “microfeature workpiece” and “workpiece” refer to substrates on or in which microelectronic devices or other microdevices are integrally formed. Typical microdevices include microelectronic circuits or components, thin-film recording heads, data storage elements, microfluidic devices, and other products. Micromachines or micromechanical devices are included within this definition because they are manufactured using much of the same technology that is used in the fabrication of integrated circuits. The substrates can be semiconductive pieces (e.g., doped silicon wafers or gallium arsenide wafers), nonconductive pieces (e.g., various ceramic substrates), or conductive pieces.

Several embodiments of integrated tools for wet chemical processing of microfeature workpieces are described in the context of depositing metals or electrophoretic resist in or on structures of a workpiece. The integrated tools in accordance with the invention, however, can also be used for etching, rinsing or other types of wet chemical processes in the fabrication of microfeatures in and/or on semiconductor substrates or other types of workpieces. Several embodiments of tools in accordance with the invention are set forth in FIGS. 2A-9 and the following text to provide a thorough understanding of particular embodiments of the invention.

B. Embodiments of Integrated Tools with Mounting Modules

FIG. 2A is an isometric view showing a portion of an integrated tool 110 configured in accordance with an embodiment of the invention. In this embodiment, the integrated tool 110 includes a frame 109, a dimensionally stable mounting module 150 mounted to the frame 109, and a plurality of wet chemical processing stations 120, each having a processing vessel or chamber 140 and a workpiece handling apparatus 130. The processing chambers 140 are configured to perform a variety of functions including but not limited to electrochemical processing, electroless processing, etching and/or rinsing. In any of these embodiments, the workpiece handling apparatus 130 supports a workpiece W at a processing position 141 of the chamber 140. The tool 110 can also include a transport system 112 that has a robot 113 with one or more end-effectors 117. The transport system 112 is mounted to the mounting module 150. The mounting module 150 carries the processing chambers 140, the workpiece handling apparatuses 130, and the transport system 112.

The frame 109 has a plurality of posts 108 and cross-bars 107 that are welded together in a manner known in the art. A plurality of outer panels and doors are generally attached to the frame 109 to form an enclosed cabinet (not shown in FIG. 2A). The mounting module 150 is at least partially housed within the frame 109. In one embodiment, the mounting module 150 is carried by the frame 109, and in other embodiments, the mounting module 150 stands directly on the floor of the facility or another structure.

The mounting module 150 is a rigid, stable structure that maintains the relative positions between the chambers 140, the handling apparatuses 130, and the transport system 112. One aspect of the mounting module 150 is that it is much more rigid and has a significantly greater structural integrity compared to the frame 109 so that the relative positions between the chambers 140, the handling apparatuses 130, and the transport system 112 do not change over time. Another aspect of the mounting module 150 is that it includes a dimensionally stable deck 151 with positioning elements at precise locations for positioning the processing chambers 140 and the handling apparatuses 130 at known locations on the deck 151. In one embodiment (not shown), the transport system 112 can be mounted directly to the deck 151. In other embodiments, the mounting module 150 also has a dimensionally stable platform 152 (located, for example, below the deck 151) and the transport system 112 is mounted to the platform 152. The deck 151 and the platform 152 are, fixedly positioned relative to each other so that positioning elements on the deck 151 and positioning elements on the platform 152 do not move relative to each other. The mounting module 150 accordingly provides a system in which the processing chambers 140 and the handling apparatuses 130 can be removed and replaced with interchangeable components in a manner that accurately positions the replacement components at precise locations on the deck 151.

The tool 110 is particularly suitable for processes that have demanding specifications, for example, processes that require frequent maintenance of the processing chambers 140, the handling apparatuses 130, or the transport system 112. A processing chamber 140 can be repaired or maintained by simply detaching the chamber from the processing deck 151 and replacing the chamber 140 with an interchangeable chamber having mounting hardware configured to interface with the positioning elements on the deck 151. Because the mounting module 150 is dimensionally stable and the mounting hardware of the replacement processing chamber 140 interfaces with the deck 151, the chamber 140 can be interchanged on the deck 151 without having to recalibrate the transport system 114. This is expected to significantly reduce the downtime associated with repairing or maintaining the processing chamber 140 so that the tool 110 can maintain a high throughput in applications that have stringent performance specifications.

FIG. 2B is a top plan view of the tool 110 illustrating the transport system 112 and a modular load/unload system 115 attached to the mounting module 150. Referring to FIGS. 2A and 2B together, the transport system 112 includes a track 114, a robot 113, and at least one end-effector 117. The track 114 is mounted to the platform 152 in the embodiment shown in FIGS. 2A and 2B. More specifically, the track 114 interfaces with positioning elements on the platform 152 to accurately position the track 114 relative to the chambers 140 and the handling apparatuses 130 attached to the deck 151. The robot 113 and the end-effectors 117 can accordingly move in a pre-determined reference frame established by the mounting module 150. Referring to FIG. 2B, the tool 110 can further include a plurality of panels 106 attached to the frame 109 to enclose the mounting module 150, the processing chamber 140, the handling apparatuses 130, and the transport system 112 in a cabinet. In other embodiments, the panels 106 on one or both sides of the tool 110 can be removed in the region above the processing deck 151 to provide an open tool.

C. Embodiments of Dimensionally Stable Mounting Modules

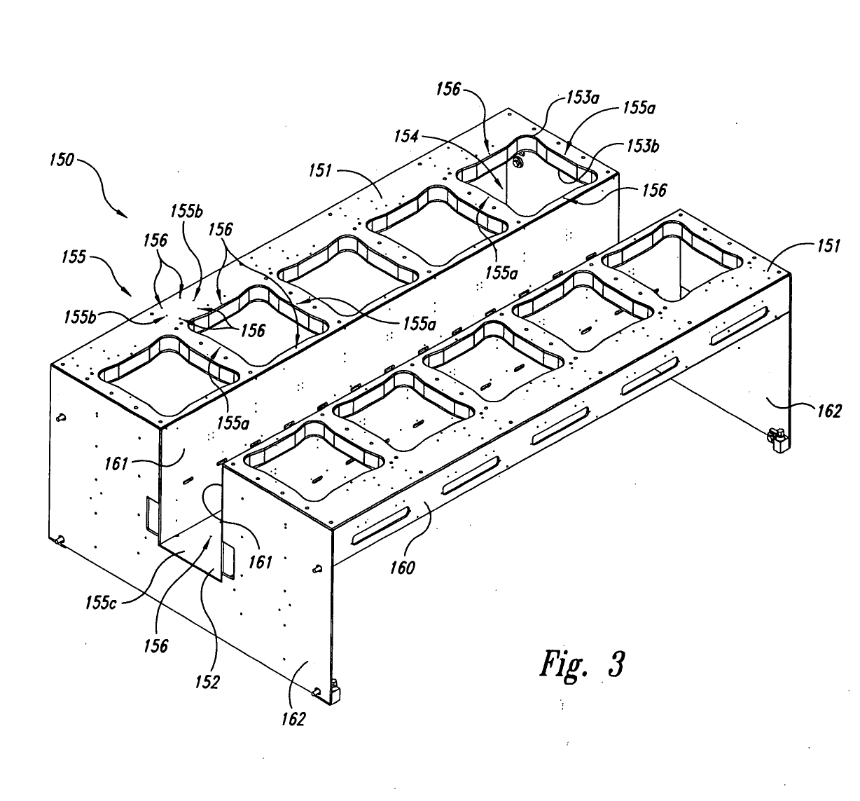

FIG. 3 is an isometric view of a mounting module 150 configured in accordance with an embodiment of the invention for use in the tool 110 (FIGS. 2A-2B). In this embodiment, the deck 151 includes a first rigid panel 153a and a second rigid panel 153b positioned underneath the first panel 153a. The first panel 153a can be an outer member and the second panel 153b can be an interior member. The first and second panels 153a, 153b can also have different configurations than the configuration in FIG. 3. A plurality of receptacles 154 are disposed in the first and second panels 153a, 153b to receive the processing chambers 140 (FIG. 2A).

The deck 151 can further include a plurality of positioning elements 155 and attachment elements 156 arranged in a precise pattern across the first panel 153a. The positioning elements 155 can be holes machined in the first panel 153a at precise locations and with precise dimensions to receive dowels or pins that interface with second positioning elements of the processing chambers 140 (FIG. 2A). In other embodiments, the positioning elements 155 can be pins, such as cylindrical pins or conical pins, that project upwardly from the first panel 153a to be received by mating second positioning elements in the processing chambers 140. In a further aspect of either embodiment, the deck 151 can include a set of first chamber positioning elements 155a located at each receptacle 154 to accurately position the individual processing chambers 140 at precise locations on the mounting module 150. The deck 151 also includes a set of first apparatus positioning elements 155b and elements 156b near each receptacle 154 to accurately position the handling apparatuses 130 at precise locations on the mounting module 150. The first apparatus positioning elements 155b are positioned and configured to mate with corresponding positioning elements of the handling apparatuses 130. In one embodiment, the attachment elements 156 for the chambers 140 and/or the handling apparatuses 130 include threaded holes in the first panel 153a that receive bolts to secure the chambers 140 and the handling apparatuses 130 to the deck 151. In other embodiments, the attachment elements 156 include other devices.

The mounting module 150 also includes exterior side plates 160 along longitudinal outer edges of the deck 151, interior side plates 161 along longitudinal inner edges of the deck 151, and endplates 162 attached to the ends of the deck 151. The transport platform 152 is attached to the interior side plates 161 and the end plates 162. The transport platform 152 includes track positioning elements 155c for accurately positioning the track 114 (FIGS. 2A and 2B) on the mounting module 150. The transport platform 152 can further include attachment elements 156, such as tapped holes, that receive bolts to secure the track 114 to the platform 152.

The mounting module 150 provides a heavy-duty, dimensionally stable structure in which the relative positions between the positioning elements 155a, 155b on the deck 151 and the positioning elements 155c on the platform 152 are maintained within a range that does not require the transport system 112 to be recalibrated each time a replacement processing chamber 140 or handling apparatus 130 is mounted to the deck 151. The mounting module 150 is generally a rigid structure that is sufficiently strong to maintain the relative positions among the positioning elements 155a-155c when the processing chamber 140, the handling device 130, and the transport system 112 (FIGS. 2A-2B) are mounted to the mounting module 150. In several embodiments, the mounting module 150 is configured to maintain the relative positions between the positioning elements 155a, 155b on the deck 151 and the positioning elements 155c on the platform 152 to within 0.025 inch. In other embodiments, the mounting module 150 is configured to maintain the relative positions between the positioning elements 155 to within approximately 0.005 to 0.015 inch. As such, the deck 151 often maintains a uniformly flat surface to within approximately 0.025 inch, and in more specific embodiments to approximately 0.005-0.015 inch. Other aspects of the mounting module 150 are disclosed in U.S. Application No. 60/476,786 incorporated by reference above.

D. Workpiece Handling Units for Use With Processing Vessels

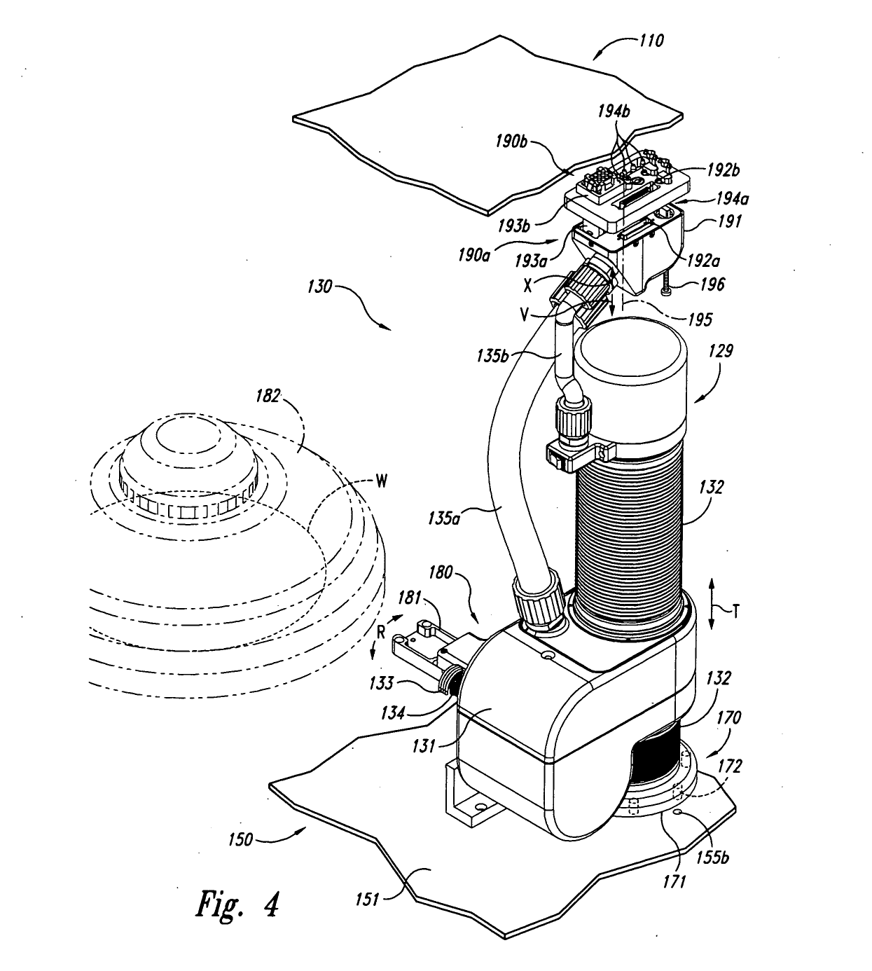

FIG. 4 is a partially schematic, partially exploded isometric illustration of a workpiece handling apparatus 130 configured to releasably mount to the mounting module 150 in accordance with an embodiment of the invention. In one aspect of this embodiment, the apparatus 130 includes a moveable head 182 that carries a microfeature workpiece W. The head 182 is coupled to a head mount 181 that rotates the head 182 as indicated (by arrow R) to position the workpiece W face up or face down. The head mount 181 is carried by a workpiece support 180 having a housing 131 and being configured to move upwardly and downwardly (as indicated by arrow T) to move the head 182 and the workpiece W toward and away from the processing chamber 140 (FIGS. 2A-2B). Connector assemblies 190a, 190b provide fluid and electrical communication between the workpiece handling apparatus 130 and the rest of the tool 110. A mounting portion 170 is configured to precisely and releasably secure the workpiece handling apparatus 130 to the tool deck 151, as described in greater detail below.

In one aspect of an embodiment shown in FIG. 4, the mounting portion 170 includes a downwardly facing mounting surface 171. In a further aspect of this embodiment, the mounting surface 171 is precisely machined to mount flush against the deck 151. Accordingly, the mounting surface 171 and the deck 151 precisely orient the handling apparatus 130 relative to the tool 110 in the vertical direction. In a further aspect of this embodiment, the mounting portion 170 includes second apparatus positioning elements 172 positioned to precisely mate with the corresponding first apparatus positioning elements 155b at the deck 151. For example, in one embodiment, the first apparatus positioning elements 155b include and/or carry pins and the second apparatus positioning elements 172 include apertures sized and positioned to snuggly receive the pins. In another embodiment, the second apparatus positioning elements 172 include and/or carry pins and the first apparatus positioning elements 155b include apertures. In other embodiments, the configurations of the first apparatus positioning elements 155b and the second apparatus positioning elements 172 are different. In any of these embodiments, the correspondence between the first apparatus positioning elements 155b and the second apparatus positioning elements 172 is precisely maintained from one workpiece handling apparatus 130 to the next. As a result, a workpiece handling apparatus 130 can be removed from the deck 151 and replaced with another workpiece handling apparatus 130 without requiring that the new apparatus 130 be recalibrated.

When the workpiece handling apparatus 130 is connected to the tool 110, it communicates with the tool 110 via fluid communication lines 133 and electrical communication lines 134. Accordingly, an embodiment of the workpiece handling apparatus 130 includes a first connector assembly 190a configured to releasably connect to a second connector assembly 190b carried by the tool 110. In a particular aspect of this embodiment, the first connector assembly 190a includes a housing 191 carrying a low voltage connector 192a (e.g., for transmitting data signals to and from the workpiece handling apparatus 130), a high voltage connector 193a (e.g., for transmitting electrical power to the handling apparatus 130), and fluid connectors 194a (hidden from view in FIG. 4 and provided e.g., to supply pressurized air, purge gas, and/or vacuum to the workpiece handling apparatus 130). The second connector assembly 190b includes a corresponding low voltage connector 192b, a high voltage connector 193b, and fluid connectors 194b. In yet a further aspect of this embodiment, the first connector assembly 190a is connected to and released from the second connector 190b with motion along a single connector motion axis 195, as indicated by arrows X and V. In one embodiment, a user can move the first connector assembly 190a by grasping the connector housing 191 and moving it along the connector motion axis 195. In another embodiment, for example, when a substantial insertion force is required to mate the first connector assembly 190a with the second connector assembly 190b, the first connector assembly 190a includes a captive screw 196 that the user threadably attaches to the second connector assembly 190b to draw the two connector assemblies 190a, 190b together.

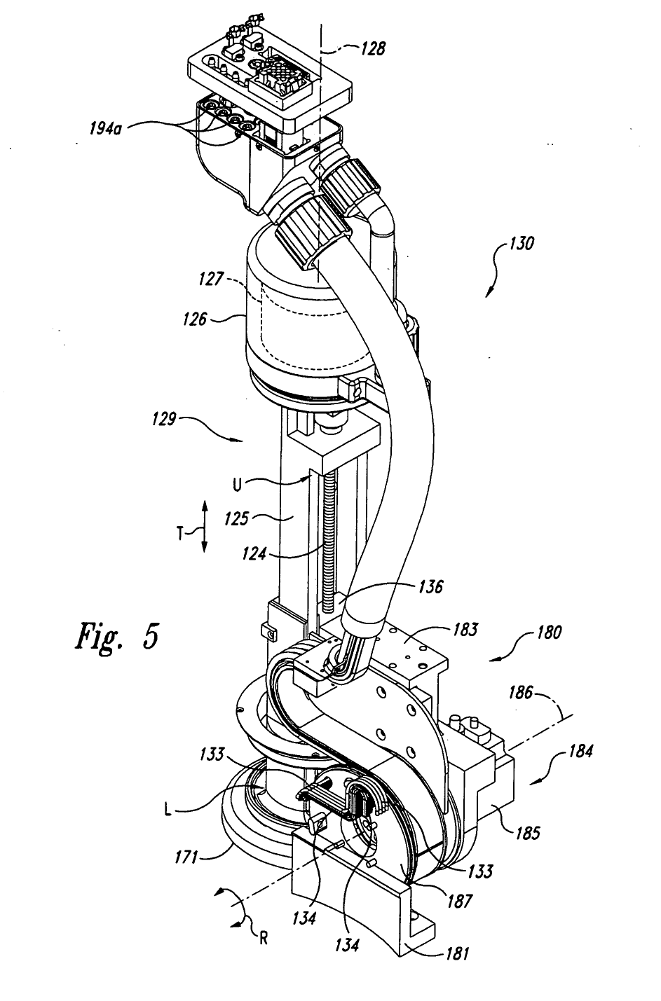

In one embodiment, one set of fluid communication lines 133 and electrical communication lines 134 are routed from the first connector assembly 190a through a first conduit 135a to the workpiece support 180. A second set of fluid communication lines 133 and/or electrical communication lines 134 (not visible in FIG. 4) are routed through a second conduit 135b from the first connector assembly 190a to a linear drive mechanism 129. In a further aspect of this embodiment, the second conduit 135b is generally rigid and the first conduit 135a is flexible to accommodate motion of the workpiece support 180 along the translation axis T. A bellows 132 is also disposed around the linear drive mechanism 129 to accommodate the motion. In one embodiment, the bellows 132 includes Teflon® and in other embodiments, the bellows includes other flexible resilient materials of the linear drive mechanism 129. Further details of the linear drive mechanism 129 are described below with reference to FIG. 5.

FIG. 5 is an isometric illustration of the handling apparatus 130 with the housing 131 and the bellows 132 (shown in FIG. 4) removed for purposes of illustration. In one aspect of an embodiment shown in FIG. 5, the linear drive mechanism 129 includes a linear drive motor 127 positioned within a linear drive housing 126. The linear drive motor 127 is coupled to a lead screw 124, which threadably engages the workpiece support 180 at an interface 136. In other embodiments, the linear drive mechanism 129 includes other arrangements, for example, hydraulic or pneumatic actuators. In any of these embodiments, the linear drive mechanism 129 moves the workpiece support 180 upwardly and downwardly as indicated by arrow T along a linear motion axis 128, and is guided by a linear track 125. In one aspect of these embodiments, the interface 136 moves between a lowermost position L and an uppermost position U along the linear axis 128. The mounting surface 171 is positioned generally normal to the linear motion axis 128 and is located below the lowermost position L so that it does not intersect the linear motion axis 128 between the lowermost position L and the uppermost position U.

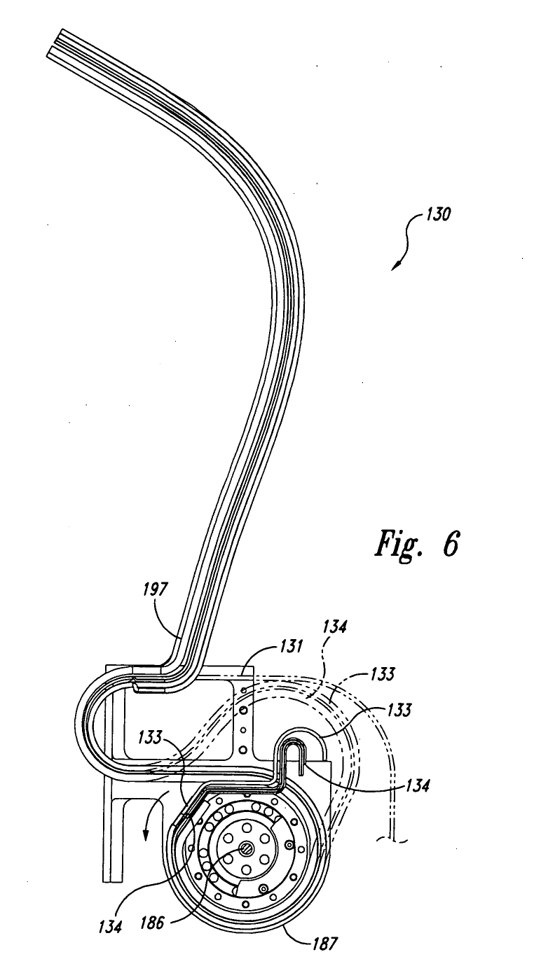

In one embodiment, the apparatus 130 also rotates the workpiece support 180. Accordingly, the apparatus 130 includes a rotary drive mechanism 184. In a particular aspect of this embodiment, rotary drive mechanism 184 includes a a rotary drive motor 185 coupled to a drum 187 which is in turn coupled to the head mount 181. In other embodiments, the rotary drive mechanism 184 includes other arrangements. In one aspect of an embodiment shown in FIG. 5, the rotary drive motor 185 rotates to the head mount 181 clockwise and counterclockwise about a rotational motion axis 186, as indicated by arrow R. In a particular aspect of this embodiment, the head mount 181 rotates by about 180° between its extreme positions. As described in greater detail below with reference to FIG. 6, the fluid communication lines 133 and electrical communication lines 134 are arranged to accommodate this range of motion without binding.

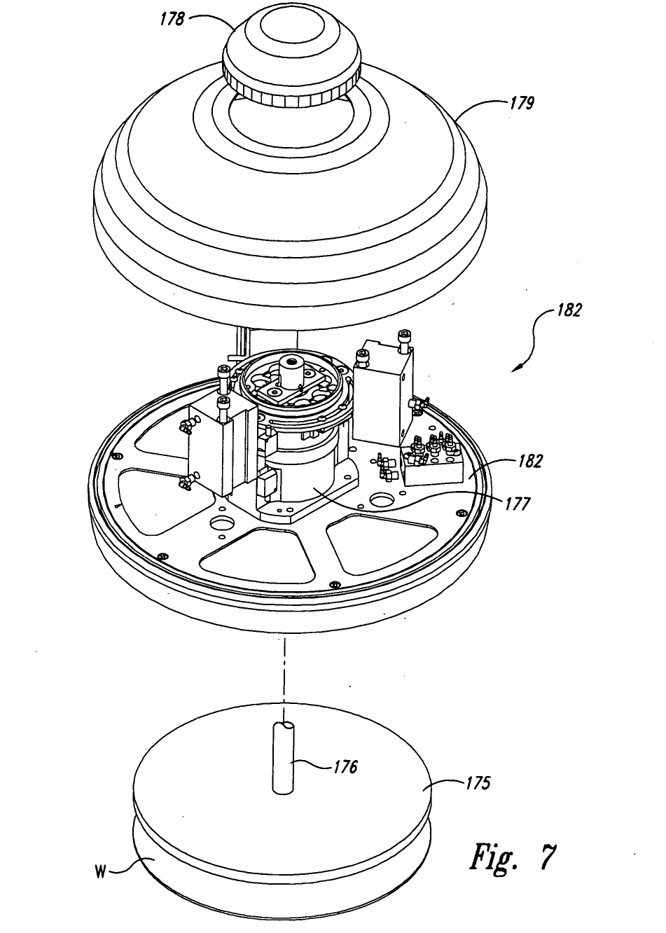

FIG. 6 is a partially schematic, side elevational view of a portion of the apparatus 130 described above with reference to FIGS. 4 and 5. In one aspect of this embodiment, the fluid communication lines 133 and the electrical communication lines 134 are carried by the drum 187 described above with reference to FIG. 5. Accordingly, the communication lines 133, 134 can extend from the generally fixed conduit 135a to the rotating drum 187. As the drum 187 rotates counterclockwise about the rotational motion axis 186, the communication lines 133, 134 tend to unwind and lift off the drum 187, as indicated in FIG. 6 by phantom lines. In a particular aspect of this embodiment, the housing 131 is shaped to control and confine the motion of the unwinding communication lines 133, 134, so that when the drum 187 rotates clockwise, the communication lines 133, 134 re-seat on the drum 187. In other embodiments, the communication lines 133, 134 can have other arrangements. In any of these embodiments, the communication lines 133, 134 attach to the head 182, which is described in greater detail below with reference to FIG. 7.

Referring now to FIG. 7, an embodiment of the head 182 includes a disc-shaped platform 188 carrying a motor 177. The motor 177 is connected to a shaft 176, which is in turn connected to a support 175. The support 175 releasably carries the microfeature workpiece W and, in certain applications, provides electrical communication to the microfeature workpiece W, for example when the process performed on the microfeature workpiece W is an electrochemical deposition process. A protective cover 179 and cap 178 are disposed over the motor 177 to shield the motor 177 and other components from the environment within the tool 110.

One feature of several embodiments of the tool 110 and the workpiece handling apparatus 130 described above is that the workpiece handling apparatus 130 is connected to the tool 110 at the deck 151. For example, in a particular aspect of this embodiment, the mounting surface 171 (which mates with the deck 151) is positioned below the lowermost travel point of the interface 136 with the workpiece support 180. Accordingly, even if the workpiece W and/or portions of the head 180 extend below the deck 151 during processing, the mounting surface 171 is positioned at the deck 151. An advantage of this arrangement is that the workpiece handling apparatus 130 is less likely to impede access to components of the tool 110 positioned below the deck 151. Such components include plumbing lines, pumps, valves, and associated hardware. Because the workpiece handling apparatus 130 is less likely to impede access to these components, these components can be serviced without removing the workpiece handling apparatus 130, which in turn reduces the time required to maintain and/or replace components located below the deck 151.

Another feature of embodiments of the workpiece handling apparatus 130 described above is that it need not be calibrated after being attached to the tool 110. For example, in one embodiment, neither the mounting portions 170, nor any structure connected between the mounting portion 170 and the drive mechanism 129 includes an adjustable, mechanical device positioned to locate the workpiece support 180 relative to the rest of the tool 110. In particular, the positioning elements 155b and 172 precisely align the workpiece handling apparatus 130 with the tool 110. So long as components of the workpiece handling apparatus 130 are aligned relative to the positioning elements 172 and/or the mounting surface 171 prior to installation on the tool 110 (e.g., during manufacture), these components need not be recalibrated when the workpiece handling device 130 is installed. An advantage of this arrangement is that the workpiece handling apparatus 130 can be fabricated so as to be fully calibrated and accordingly the length of time during which the tool is non-operational (e.g., during installation of a replacement workpiece handling apparatus 130) need not be increased merely to recalibrate the workpiece handling device 130.

Another feature of an embodiment of the workpiece handling apparatus 130 described above is that the electrical and fluid communication lines 133, 134 between the workpiece handling apparatus 130 and the rest of the tool 110 are removably coupled at a single point. For example, in particular, an embodiment of the workpiece handling apparatus 130 includes a single connector assembly 190a that provides both electrical and fluid communication with the tool 110. In a further aspect of this embodiment, the single connector assembly 190a can be attached to a corresponding connector assembly 190b of the tool 110 with motion along a single axis. An advantage of both features is that the workpiece handling apparatus 130 is accordingly more quickly and easily removed and replaced than are existing workpiece handling apparatuses.

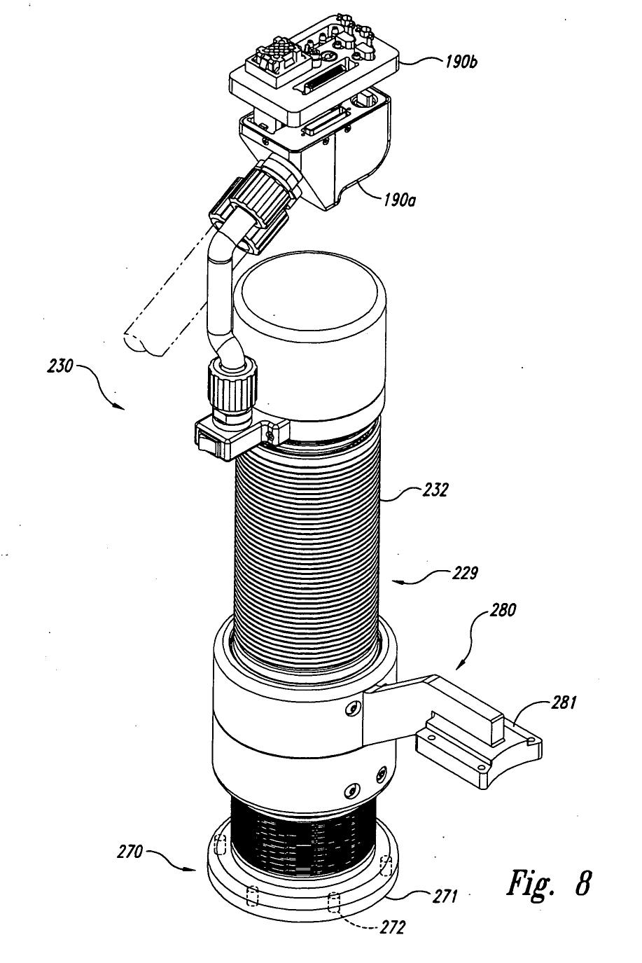

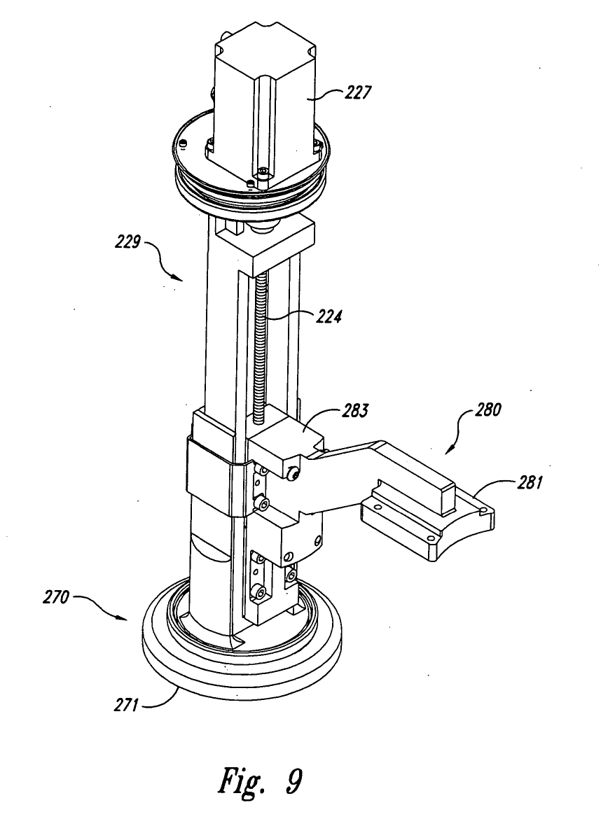

FIG. 8 is a partially schematic, isometric illustration of a workpiece handling apparatus 230 having a workpiece support 280 with a head mount 281 that translates but does not rotate, in accordance with another embodiment of the invention. In one aspect of this embodiment, other elements of the apparatus 130 are generally similar to corresponding elements described above with reference to FIGS. 4-7. For example, the apparatus 230 includes connector assemblies 190a, 190b that handle fluid and electrical communication between the workpiece handling apparatus 230 and other portions of the tool 110 (FIGS. 2A-2B) at a single connection point. The workpiece handling apparatus 230 includes a mounting portion 270 having a flat mounting surface 271 and positioning elements 272 that align the apparatus 230 relative to the deck 151 of the apparatus described above. A bellows 232 is positioned around portions of a linear drive mechanism 229, which is described in greater detail below with reference to FIG. 9.

FIG. 9 is a partially schematic, isometric illustration of an embodiment of the apparatus 230 described above with reference to FIG. 8, with the bellows 232 removed. As shown in FIG. 9, the linear drive mechanism 229 includes a linear drive motor 227 coupled with a lead screw 224 to a driven portion 283 of the head mount 281. In other embodiments, the linear drive mechanism 229 can have other arrangements. In any of these embodiments, the linear motion of the head mount 281 is sufficient to position the workpiece W (not shown in FIG. 9) at the desired location of the processing station 120 (FIG. 2A). Such an arrangement is used for particular application processes, including bevel etching the microfeature workpiece W in a capsule chamber.

From the foregoing, it will be appreciated that although specific embodiments of the invention have been described for purposes of illustration, various modifications may be made without deviating from the spirit and the scope of invention. Accordingly, the invention is not limited except as by the appended claims.

1. An apparatus for handling microfeature workpieces, comprising:
a microfeature workpiece support configured to carry a microfeature workpiece during processing, the microfeature workpiece support having a driven portion;
a drive unit coupled to the microfeature workpiece support at an interface with the driven portion to translate the microfeature workpiece support along a generally linear translation axis as the interface moves from a first end position to a second end position spaced apart from the first end position; and
a mounting portion coupled to the microfeature workpiece support, the mounting portion having a mounting surface positioned to mate with a corresponding surface of a microfeature workpiece processing tool, the mounting surface being positioned in an alignment plane that does not intersect the translation axis between the first and second end positions.

2. The apparatus of claim 1 wherein the first end position is the extreme position of the interface in a first direction along the translation axis and the second end position is the extreme position of the interface in a second direction along the translation axis, the second direction being opposite to the first direction.

3. The apparatus of claim 1 wherein the drive unit includes a first drive unit and wherein the apparatus further comprises a second drive unit operatively coupled to the microfeature workpiece support to rotate the microfeature workpiece support about a rotation axis.

4. The apparatus of claim 1, further comprising a first connector assembly that houses both electrical and fluid communication lines and is coupleable to a corresponding second connector assembly of the microfeature workpiece processing tool by relative motion of at least one of the connector assemblies relative to the other along a single axis.

5. The apparatus of claim 1 wherein the microfeature workpiece support is configured to carry the microfeature workpiece in contact with a processing liquid.

6. The apparatus of claim 1 wherein the drive unit includes an actuator coupled to a threaded leadscrew.

7. The apparatus of claim 1 wherein neither the mounting portion, nor any structure connected between the mounting portion and the drive unit includes an adjustable mechanical device positioned to locate the microfeature workpiece support relative to the corresponding surface.

8. The apparatus of claim 1, further comprising the microfeature workpiece processing tool.

9. The apparatus of claim 1, further comprising the microfeature workpiece processing tool, and wherein the microfeature workpiece processing tool includes a processing chamber positioned proximate to the microfeature workpiece support, the processing chamber having a processing position located to receive a microfeature workpiece carried by the microfeature workpiece support, the microfeature workpiece processing tool further including a transport device positioned to move the microfeature workpiece to and from the microfeature workpiece support.

10. The apparatus of claim 1, further comprising a flexible bellows disposed around the generally linear translation axis.

11. An apparatus for handling microfeature workpieces, comprising:
a microfeature workpiece support configured to carry a microfeature workpiece during processing;
a drive unit coupled to the microfeature workpiece support to move the microfeature workpiece support axis from a first position to a second position spaced apart from the first position; and
a single first connector assembly carrying at least one electrical communication line and at least one fluid communication line, the first connector assembly being coupleable to a corresponding second connector assembly of the microfeature workpiece processing tool by relative motion of at least one of the connector assemblies along a single axis.

12. The apparatus of claim 11, further comprising the second connector assembly.

13. The apparatus of claim 11 wherein the at least one fluid communication line includes at least one pressure line and at least one vacuum line.

14. The apparatus of claim 11, further comprising:
the second connector assembly; and
a threaded member carried by one of the connector assemblies and configured to be threadably received by the other connector assembly, and wherein rotational motion of the threaded member in a first direction draws the connector assemblies toward each other along the single axis, and wherein rotational motion of the threaded member in a second direction opposite the first direction moves the connector assemblies away from each other along the single axis.

15. The apparatus of claim 11, further comprising the microfeature workpiece processing tool.

16. The apparatus of claim 11, further comprising the microfeature workpiece processing tool, and wherein the microfeature workpiece processing tool includes a processing chamber positioned proximate to the microfeature workpiece support, the processing chamber having a processing position located to receive a microfeature workpiece carried by the microfeature workpiece support, the microfeature workpiece processing tool further including a transport device positioned to move the microfeature workpiece to and from the microfeature workpiece support.

17. The apparatus of claim 11 wherein the drive unit includes a first drive unit coupled to the microfeature workpiece support to translate the microfeature workpiece support along a generally linear translation axis, and wherein the apparatus further comprises a second drive unit coupled to the microfeature workpiece support to rotate the microfeature workpiece support about a rotation axis.

18. An apparatus for handling microfeature workpieces, comprising:
a microfeature workpiece support configured to carry a microfeature workpiece during processing;
a drive unit coupled to the microfeature workpiece support to move the microfeature workpiece support between a first position and a second position along a generally linear translation axis; and
a mounting portion having a mounting surface positioned to mate with a corresponding surface of a microfeature workpiece processing tool, wherein neither the mounting portion, nor any structure connected between the mounting portion and the drive unit includes an adjustable mechanical device positioned to locate the workpiece support relative to the corresponding surface.

19. The apparatus of claim 18 wherein the drive unit includes a first drive unit along a generally linear translation axis coupled to the microfeature workpiece support to translate the microfeature workpiece support and wherein the apparatus further comprises a second drive unit operatively coupled to the microfeature workpiece support to rotate the support about a rotation axis.

20. The apparatus of claim 18, further comprising a single first connector assembly carrying electrical and fluid communication lines and being coupleable to a corresponding second connector assembly of the microfeature workpiece processing tool.

21. The apparatus of claim 18 wherein the mounting portion includes at least one of an alignment pin positioned to be received in a corresponding aperture of the workpiece processing tool, and an aperture positioned to receive an alignment pin of the workpiece processing tool.

22. An apparatus for processing microfeature workpieces, comprising:
a device support having a first alignment surface at an alignment plane, the alignment plane having a chamber aperture;
a processing chamber received in the chamber aperture, the processing chamber being configured to receive at least one processing liquid; and
a workpiece handling device proximate to the processing chamber and including:
a microfeature workpiece support positioned to carry the microfeature workpiece at a processing position of the processing chamber;
a drive unit operatively coupled to the microfeature workpiece support to translate the microfeature workpiece support along a generally linear motion axis relative to the processing chamber; and
a mounting portion coupled to the microfeature workpiece support and having a second alignment surface removably mated with the first alignment surface, with the workpiece handling device being supported relative to the device support only at or above the alignment plane.

23. The apparatus of claim 22 wherein the workpiece handling device includes a single connector carrying housing electrical and fluid communication lines and being coupleable to a corresponding connector assembly of the microfeature workpiece processing tool.

24. The apparatus of claim 22 wherein the drive unit includes a first drive unit, and wherein the apparatus further comprises a second drive unit operatively coupled to the microfeature workpiece support to rotate the microfeature workpiece support about a rotation axis.

25. The apparatus of claim 22 wherein the processing chamber is configured to receive at least one of an electrochemical processing liquid, an electroless processing liquid, an etchant and a rinse liquid.

26. The apparatus of claim 22 wherein the chamber extends below the alignment plane.

27. The apparatus of claim 22 wherein the alignment plane is a first alignment plane and wherein the drive unit translates the microfeature workpiece support between a first end position and a second end position and wherein the second alignment surface is positioned in a second alignment plane that does not intersect the translation axis between the first and second positions.

28. An apparatus for processing microfeature workpieces, comprising:
device support means for carrying a processing chamber, the device support means having a first alignment surface at an alignment plane, the alignment plane having a chamber aperture;
chamber means for processing a microfeature workpiece, the chamber means being received in the chamber aperture; and
workpiece handling means that includes:
microfeature workpiece support means for carrying the microfeature workpiece at a processing position of the processing chamber;
drive means for translating the support means along a generally linear motion axis; and
mounting means for supporting the workpiece handling means relative to the device support means, the mounting means having a second alignment surface removably mated with the first alignment surface, with the workpiece handling device being supported relative to the device support only at or above the alignment plane.

29. A method for servicing a microfeature workpiece processing tool, comprising:
removing a first workpiece handling device from a workpiece processing tool, the first workpiece handling device including a first microfeature workpiece support and a first drive unit operatively coupled to the first microfeature workpiece support to translate the first microfeature workpiece support along a generally linear first translation axis;
replacing the first workpiece handling device with a second workpiece handling device, the second workpiece handling device including a second microfeature workpiece support and a second drive unit operatively coupled to the second microfeature workpiece support to translate the second microfeature workpiece support along a generally linear second translation axis; and
moving microfeature workpieces to and from the second workpiece handling device after replacing the first workpiece handling device and without calibrating the second workpiece handling device after replacing the first workpiece handling device.

30. The method of claim 29, wherein the first workpiece handling device includes a first connector, wherein the second workpiece handling device includes a second connector, wherein the workpiece processing tool includes a third connector, and wherein the method further comprises:
disconnecting both electrical and fluid communication between the first workpiece handling device and the processing tool by moving at least one of the first connector and the second connector relative to the other along a single axis; and
connecting both electrical and fluid communication between the second workpiece handling device and the processing tool by moving at least one of the second connector and the third connector relative to the other along the single axis.

31. The method of claim 29 wherein the microfeature workpiece support includes a driven portion and wherein the drive unit is coupled to the microfeature workpiece support at an interface with the driven portion to translate the support along a generally linear translation axis as the interface moves from a first end position to a second end position spaced apart from the first position, and wherein replacing the first workpiece handling device includes positioning an alignment surface of the second workpiece handling device against a corresponding alignment surface of the workpiece processing tool, with the alignment surface of the second workpiece handling device not intersecting the second translation axis between the first and second end positions.

32. A method for servicing a microfeature workpiece processing tool, comprising:
disconnecting both electrical and fluid communication to a first workpiece handling device of the processing tool by moving at least one of a first connector assembly coupled to the tool and a second connector assembly coupled to the first workpiece handling device relative to the other along a single axis in a first direction; and
connecting both electrical and fluid communication to a second workpiece handling device by moving at least one of the first connector assembly and a third connector assembly coupled to the second workpiece handling device relative to the other along the single axis in a second direction opposite from the first direction.

33. The method of claim 32 wherein disconnecting both electrical and fluid communication includes rotating a threaded member coupled between the first and second connectors.

34. The method of claim 32 wherein disconnecting fluid communication includes disconnecting at least one of a pressure line and a vacuum line.
